(19) United States
(12) Patent Application Publication
(10) Pub. No.: US 2022/0285663 A1
(43) Pub. Date: Sep. 8, 2022

(54) ROLL PRESS APPARATUS AND METHOD FOR PRODUCING COMPRESSED STRIP-SHAPED ELECTRODE SHEET

(71) Applicant: Prime Planet Energy & Solutions, Inc., Tokyo (JP)

(72) Inventors: Tomofumi HIRUKAWA, Nisshin-shi (JP); Tetsumasa MARUO, Ibaraki-shi (JP); Kengo HAGA, Nagoya-shi (JP); Kota NAKAMURA, Himeji-shi (JP)

(21) Appl. No.: 17/589,903

(22) Filed: Feb. 1, 2022

(30) Foreign Application Priority Data
Mar. 5, 2021 (JP) 2021-035398

(51) Int. Cl. H01M 4/04

(52) U.S. Cl. CPC H01M 4/0435

(57) ABSTRACT

A roll press apparatus for producing a compressed strip-shaped electrode sheet from a strip-shaped electrode sheet including an active material portion and an active-material absent portion is provided with a pair of press rolls arranged in parallel with a roll gap and configured to roll-press the strip-shaped electrode sheet being conveyed in a longitudinal direction for compression to form a compressed active material layer, and an active-material-absent-portion stretching unit arranged upstream of the press rolls and configured to stretch the active-material absent portion of the strip-shaped electrode sheet in the longitudinal direction.

### CROSS-REFERENCE TO RELATED APPLICATIONS

This application is based upon and claims the benefit of priority to Japanese Patent Application No. 2021-035398 filed on Mar. 5, 2021, the entire contents of which are incorporated herein by reference.

### BACKGROUND

### Technical Field

The present disclosure relates to a roll press apparatus for forming a compressed strip-shaped electrode sheet by roll-pressing a strip-shaped electrode sheet and a method for producing a compressed strip-shaped electrode sheet by roll-pressing a strip-shaped electrode sheet.

### Related Art

As an electrode sheet to be used for a lithium ion secondary battery or the like, there has been known a compressed strip-shaped electrode sheet including a strip-shaped current collecting foil and a compressed active material layer pressed in a thickness direction and compressed on the current collecting foil. Further, such an electrode sheet includes a compressed strip-shaped electrode sheet 901, as shown in FIG. 6, configured such that a central part in a width direction FH is formed as a strip-shaped post-press active material portion 911 having compressed active material layers 905 and 906 located above and below in a thickness direction GH and both side parts in the width direction FH are each formed as a strip-shaped post-press active-material absent portion 912 having neither the compressed active material layer 905 nor the compressed active material layer 906. In the present specification, a post-press active material portion and a post-press active-material absent portion are respectively an active material portion and an active-material absent portion that has been subjected to a press process.

This compressed strip-shaped electrode sheet 901 can be produced by for example the following method. Firstly, undried active material layers 905X and 906X are formed in a strip shape on a strip-shaped current collecting foil 903 at the center in the width direction FH. Then, these layers 905X and 906X are dried by heating to respectively form strip-shaped active material layers 905Z and 906Z. Secondly, a strip-shaped electrode sheet 901Z provided with those active material layers 905Z and 906Z is roll-pressed while being conveyed in a longitudinal direction EH to compact, or compress, the active material layers 905Z and 906Z in the thickness direction GH to form the compressed active material layers 905 and 906. The compressed strip-shaped electrode sheet 901 is thus completed. As a conventional art related to the above method, for example, there is Japanese unexamined patent application publication No. 2017-228349.

### SUMMARY

### Technical Problems

However, during roll press of the strip-shaped electrode sheet 901Z, especially, a part of each of active-material absent portions 912Z (the post-press active-material absent portions 912) near the boundary between each active-material absent portion 912Z (each post-press active-material absent portion 912) and the active material portion 911Z (the post-press active material portion 911), oblique wrinkles SW extending obliquely from the inside in the width direction FH and the upstream side toward the outside in the width direction FH and the downstream side EDH may repeatedly occur.

The reason why such oblique wrinkles SW occur is considered to be as follows. Specifically, in the compressed strip-shaped electrode sheet 901 after roll press, the post-press active material portion 911 has been stretched in the longitudinal direction EH, whereas the post-press active-material absent portions 912, which are thinner than the active material portion 911, are hardly pressed and thus have been little stretched. Therefore, the post-press active material portion 911 of the compressed strip-shaped electrode sheet 901 after roll press slackens, so that the tension applied to the compressed strip-shaped electrode sheet 901 toward the downstream side EDH is hardly applied to the post-press active material portion 911 but is applied to the post-press active-material absent portions 912. When a large downstream tension is applied to the post-press active-material absent portions 912 as above, the reaction force is concentrically generated in a part of each post-press active-material absent portion 912 near the boundary between each post-press active-material absent portion 912 and the post-press active material portion 911. This concentrically generated reaction force may conceivably cause oblique wrinkles SW near the above boundary.

The present disclosure has been made to address the above problems and has a purpose to provide a roll press apparatus capable of roll-pressing a strip-shaped electrode sheet having an active material portion and an active-material absent portion while suppressing the generation of wrinkles in the active-material absent portion (a post-press active-material absent portion), and a method for producing a compressed strip-shaped electrode sheet while preventing the generation of wrinkles in the post-press active-material absent portion.

### Means of Solving the Problems

To achieve the above-mentioned purpose, one aspect of the present disclosure provides a roll press apparatus configured to form a compressed strip-shaped electrode sheet from a strip-shaped electrode sheet, the strip-shaped electrode sheet including a strip-shaped current collecting foil and a strip-shaped active material layer located on the current collecting foil and extended in a longitudinal direction of the current collecting foil to provide: a strip-shaped active material portion extended in the longitudinal direction and including the active material layer in a thickness direction of the current collecting foil; and a strip-shaped active-material absent portion extended in the longitudinal direction and arranged adjacent to the active material portion in a width direction of the current collecting foil, wherein the active-material absent portion does not include the active material layer in the thickness direction and has a thinner thickness than the active material portion, the compressed strip-shaped electrode sheet including a compressed active material layer formed by compression of the active material layer, wherein the roll press apparatus includes: a pair of press rolls arranged in parallel with each other with a roll gap, the press rolls being configured to roll-press the strip-shaped electrode sheet being conveyed in the longitudinal direction to compress the active material layer to form the compressed active material layer; and an active-material-absent-portion stretching unit arranged upstream of the pair of press rolls and configured to stretch the active-material absent portion of the strip-shaped electrode sheet in the longitudinal direction.

In the foregoing roll press apparatus, the active-material-absent-portion stretching unit is placed upstream of the pair of press rolls. This active-material-absent-portion stretching unit is configured to stretch the active-material absent portion of the strip-shaped electrode sheet in the longitudinal direction before the strip-shaped electrode sheet is roll-pressed by the pair of press rolls. Accordingly, in the compressed strip-shaped electrode sheet after roll press, not only the post-press active material portion has been stretched in the longitudinal direction by the press rolls but also the post-press active-material absent portion has been stretched in the longitudinal direction by the active-material-absent-portion stretching unit. For this reason, the post-press active material portion of the compressed strip-shaped electrode sheet after roll press is prevented from slackening and the tension applied to the compressed strip-shaped electrode sheet toward the downstream side is applied not only to the post-press active-material absent portion but also to the post-press active material portion. This can suppress a large reaction force from concentrating on a part of the post-press active-material absent portion near the boundary between the post-press active-material absent portion and the post-press active material portion, and can prevent oblique wrinkles from occurring in the post-press active-material absent portion concentrically near that boundary. Using the roll press apparatus configured as above, it is possible to roll-press the strip-shaped electrode sheet including the active material portion and the active-material absent portion while suppressing the occurrence of wrinkles in the active-material absent portion, i.e., the post-press active-material absent portion.

The strip-shaped electrode sheet may include for example a strip-shaped electrode sheet configured that a strip-shaped active material portion is located in the central part in the width direction and strip-shaped active-material absent portions are each arranged adjacently on each side of the active material portion in the width direction. Alternatively, it may also include a strip-shaped electrode sheet configured that a plurality of strip-shaped active material portions and a plurality of strip-shaped active-material absent portions are alternately arranged in the width direction.

The active-material absent portion may include for example an active-material absent portion formed of only a current collecting foil and besides an active-material absent portion formed of a current collecting foil formed thereon with a protective layer having a thinner thickness than the active material layer.

In the foregoing roll press apparatus, furthermore, the active-material-absent-portion stretching unit includes a stretching roll configured to come into pressure contact with the active-material absent portion of the strip-shaped electrode sheet to strain and stretch the active-material absent portion in the longitudinal direction.

In the roll press apparatus configured as above, the active-material-absent-portion stretching unit includes the above-mentioned stretching roll. Thus, this active-material-absent-portion stretching unit can easily stretch the active-material absent portion of the strip-shaped electrode sheet in the longitudinal direction.

Another aspect of the present disclosure provides a method for producing a compressed strip-shaped electrode sheet, the compressed strip-shaped electrode sheet including: a strip-shaped current collecting foil; and a compressed active material layer compressed in a thickness direction of the current collecting foil, wherein the compressed strip-shaped electrode sheet is formed of a strip-shaped electrode sheet, the strip-shaped electrode sheet including the current collecting foil and a strip-shaped active material layer located on the current collecting foil and extended in a longitudinal direction of the current collecting foil to provide: a strip-shaped active material portion extended in the longitudinal direction and including the active material layer in the thickness direction of the current collecting foil; and a strip-shaped active-material absent portion extended in the longitudinal direction and arranged adjacent to the active material portion in a width direction of the current collecting foil, wherein the active-material absent portion does not include the active material layer in the thickness direction and has a thinner thickness than the active material portion; and wherein the method includes: active-material-absent-portion stretching of stretching the active-material absent portion of the strip-shaped electrode sheet in the longitudinal direction of the current collecting foil; and pressing of roll-pressing the strip-shaped electrode sheet being conveyed after the active-material-absent-portion stretching to compress the active material layer to form the compressed strip-shaped electrode sheet including the compressed active material layer.

In the production method of the compressed strip-shaped electrode sheet, the active-material absent portion of the strip-shaped electrode sheet is stretched in the longitudinal direction in the active-material-absent-portion stretching before the pressing. In the compressed strip-shaped electrode sheet after roll press as described above, therefore, the post-press active material portion has been stretched in the longitudinal direction and also the post-press active-material absent portion has been stretched in the longitudinal direction. Accordingly, the tension applied to the compressed strip-shaped electrode sheet toward the downstream side is applied not only to the post-press active-material absent portion but also to the post-press active material portion. This can prevent a large reaction force from concentrating on a part of the post-press active-material absent portion located near the boundary between the post-press active-material absent portion and the post-press active material portion, thereby preventing the generation of oblique wrinkles in the post-press active-material absent portion. This production method configured as above can thus produce a compressed strip-shaped electrode sheet with reduced generation of wrinkles in the post-press active-material absent portion.

In the foregoing production method of the compressed strip-shaped electrode sheet, furthermore, a difference between a stretch ratio of the active-material absent portion stretched in the longitudinal direction in the active-material-absent-portion stretching and a stretch ratio of the active material portion stretched in the longitudinal direction in the pressing is 0.3% or less, which is expressed by ε2−ε1≤0.3%, wherein ε1 is the stretch ratio of the active-material absent portion and ε2 is the stretch ratio of the active material portion.

In this production method of the compressed strip-shaped electrode sheet, the stretching ratio (ε1) (%) of the active-material absent portion to be stretched in the longitudinal direction in the active-material-absent-portion stretching and the stretching ratio (ε2) (%) of the active material portion to be stretched in the longitudinal direction in the pressing are set to have a small difference (ε2−ε1) therebetween, concretely, to establish a relationship: ε2−ε1≤0.3(%). Accordingly, it is possible to effectively prevent a large reaction force from concentrating on a part of the post-press active-material absent portion located near the boundary between the post-press active-material absent portion and the post-press active material portion and thus more effectively suppress the occurrence of wrinkles in the post-press active-material absent portion.

The stretch ratio (ε1) in the active-material-absent-portion stretching is calculated as below. On the active-material absent portion of the strip-shaped electrode sheet before the active-material-absent-portion stretching, marking lines are drawn at a predetermined interval (L1) in the longitudinal direction in advance. Then, an interval (L2) between the marking lines on the active-material absent portion after the active-material-absent-portion stretching is measured to calculate the stretch ratio: ε1=(L2−L1)/L1×100(%).

The stretch ratio (ε2) in the pressing is calculated as below. On the active material portion of the strip-shaped electrode sheet before the pressing, marking lines are drawn at a predetermined interval (L3) in the longitudinal direction in advance. Then, an interval L4 between the marking lines on the active material portion after the pressing is measured to calculate the stretch ratio: ε2=(L4−L3)/L3×100(%).

The magnitude of the stretch ratio (ε1) in the active-material-absent-portion stretching can be appropriately selected in consideration of the material, thickness, and others of the active-material absent portion within the range that causes no defects in the active-material absent portion (but ε1>0), such as breakage of the current collecting foil that forms the active-material absent portion.

The magnitude of the stretch ratio (ε2) in the pressing can be appropriately selected in consideration of the material, thickness, and others of the active material portion within the range that causes no defects in the active material portion (but ε2>0), such as breakage of the current collecting foil that forms the active material portion or cracks in the active material layer that forms the active material portion.

### BRIEF DESCRIPTION OF THE DRAWINGS

FIG. 1 is a perspective view of a compressed strip-shaped electrode sheet in an embodiment;

FIG. 2 is a flowchart of a method for producing the compressed strip-shaped electrode sheet in the embodiment;

FIG. 3 is an explanatory diagram showing a strip-shaped electrode sheet, a compressed strip-shaped electrode sheet, and a roll press apparatus, which are seen from side;

FIG. 4 is an explanatory diagram showing the strip-shaped electrode sheet and stretching rolls of an active-material-absent-portion stretching unit, which are seen from a downstream side in the embodiment;

FIG. 5 is a graph showing a relationship between a difference between a stretch ratio of an active-material absent portion and a stretch ratio of an active material portion and a size of wrinkles generated in the active-material absent portion (a post-press active-material absent portion); and

FIG. 6 is a perspective view of a compressed strip-shaped electrode sheet in a conventional art.

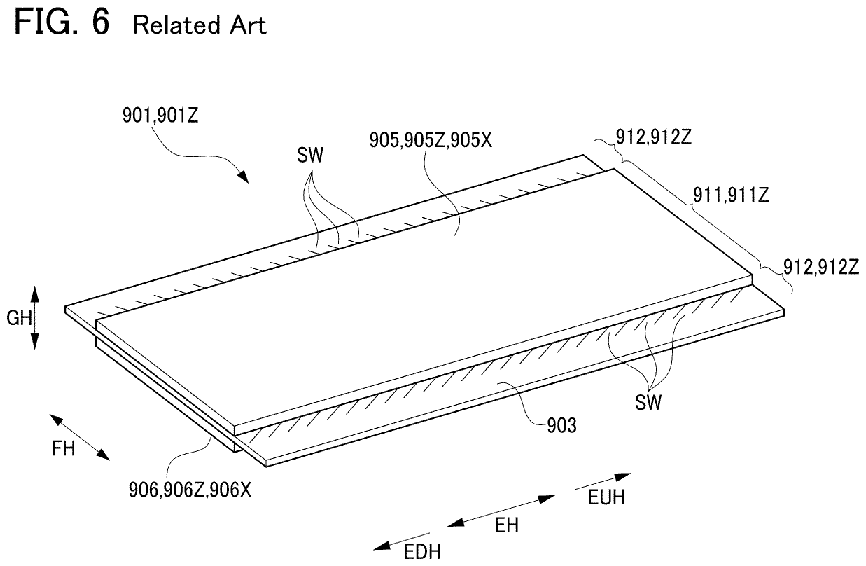

### DETAILED DESCRIPTION OF THE EXEMPLARY EMBODIMENTS

### Embodiment

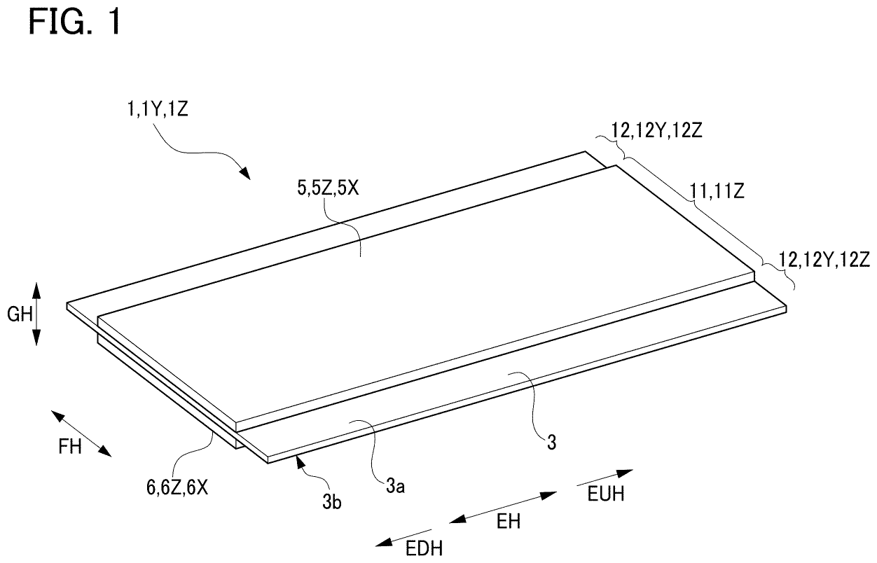

A detailed description of a first embodiment of this disclosure will now be given referring to the accompanying drawings. FIG. 1 is a perspective view of a compressed strip-shaped electrode sheet 1 in the present embodiment. This compressed strip-shaped electrode sheet 1 is used for a rectangular parallelopiped sealed lithium ion secondary battery to be mounted in a vehicle, such as a hybrid car, a plug-in hybrid car, and an electric car. To be specific, the compressed strip-shaped electrode sheet 1 is a strip-shaped positive electrode sheet to be used for a flat-wound or laminated electrode body which is a component of a battery. In the following description, the longitudinal direction EH, the width direction FH, and the thickness direction GH of the compressed strip-shaped electrode sheet 1 are assumed as illustrated in FIG. 1.

The compressed strip-shaped electrode sheet 1 includes a current collecting foil 3 made of an aluminum foil extending in a strip shape in the longitudinal direction EH and having a thickness of about 13 μm. This current collecting foil 3 has a first main surface 3a, on which a first compressed active material layer 5 is formed in a region located in the center in the width direction FH and extended in the longitudinal direction EH to extend in a strip shape in the longitudinal direction EH, the first compressed active material layer 5 being formed by pressing and compressing in the thickness direction GH to have a thickness of about 60 μm, which will be also simply referred to as a compressed active material layer 5. The current collecting foil 3 further has a second main surface 3b on an opposite side of the current collecting foil 3, on which a second compressed active material layer 6 is formed in a region located in the center in the width direction FH and extended in the longitudinal direction EH to extend in a strip shape in the longitudinal direction EH, the second compressed active material layer 6 being formed by pressing and compressing in the thickness direction GH to have a thickness of about 60 μm, which will be also simply referred to as a compressed active material layer 6. Furthermore, the current collecting foil 3 includes side parts located on both sides in the width direction FH and extended in the longitudinal direction EH, the side parts having neither the compressed active material layer 5 nor the compressed active material layer 6 to expose the current collecting foil 3 in the thickness direction GH.

The compressed active material layers 5 and 6 are each composed of active material particles, conductive particles, and a binder. In the present embodiment, the active material particles are lithium transition metal composite oxide particles, specifically, lithium nickel cobalt manganese oxide particles. Further, the conductive particles are acetylene black (AB) particles, and the binder is polyvinylidene fluoride (PVDF).

This compressed strip-shaped electrode sheet 1 includes the current collecting foil 3, and the strip-shaped compressed active material layers 5 and 6 formed on the current collecting foil 3 as described above. The central part of the compressed strip-shaped electrode sheet 1 in the width direction FH is a strip-shaped post-press active material portion 11 including the compressed active material layers 5 and 6 in the thickness direction GH. In contrast, each of the side parts of the compressed strip-shaped electrode sheet 1 in the width direction FH, which are each arranged on one of both sides of the post-press active material portion 11 in the width direction FH, is a post-press active-material absent portion 12 having neither the compressed active material layer 5 nor the compressed active material layer 6 and having a thinner thickness than the post-press active material portion 11.

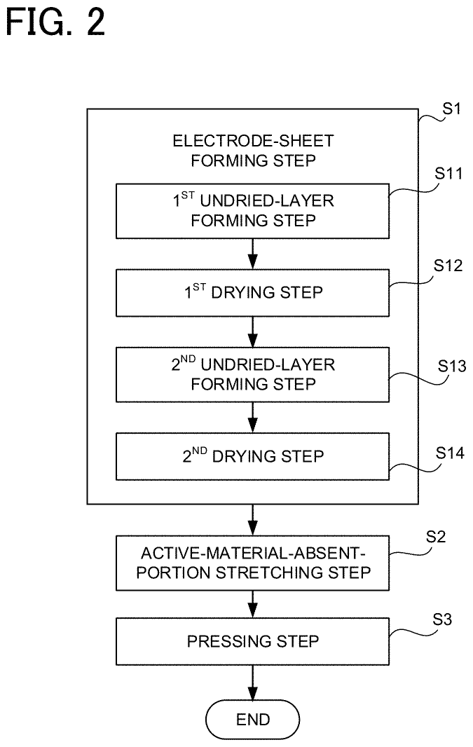

Next, a method for producing the compressed strip-shaped electrode sheet 1 will be described below, referring to FIGS. 2 to 4. In an electrode sheet forming step S1 (see FIG. 2), firstly, a strip-shaped electrode sheet 1Z before being pressed is produced. This electrode sheet forming step S1 includes a first undried-layer forming step S11, a first drying step S12, a second undried-layer forming step S13, and a second drying step S14, which are performed in this order.

In the first undried-layer forming step S11, firstly, a first undried active material layer 5X is formed in a strip shape on the first main surface 3a of the current collecting foil 3. Specifically, active material particles (lithium-nickel-cobalt-manganese composite oxide particles in the present embodiment), conductive particles (AB particles in the present embodiment), a binder (PVDF in the present embodiment), and dispersion medium (N-methyl pyrrolidone (NMP) in the present embodiment) are mixed to prepare an active material paste in advance. In the first undried-layer forming step S11, while the current collecting foil 3 is being conveyed in the longitudinal direction EH, the active material paste is ejected onto the central part of the first main surface 3a of the current collector foil 3 in the width direction FH by a coating die (not shown) to continuously form the first undried active material layer 5X in a strip shape.

Subsequently, in the first drying step S12, the strip-shaped electrode sheet obtained in the first undried-layer forming step S11 is conveyed into a drying device (not shown), and hot air is blown onto the first undried active material layer 5X for heating and drying, thereby forming a first active material layer 5Z, which will be hereinafter also simply referred to as an active material layer 5Z.

Subsequently, in the second undried-layer forming step S13, in the same manner as in the first undried-layer forming step S11, a second undried active material layer 6X is formed in a strip shape on the central part of the second main surface 3b in the width direction FH, located on the opposite side of the current collector foil 3.

In the second drying step S14, in the same manner as in the first drying step S12, hot air is blown onto the second undried active material layer 6X of the strip-shaped electrode sheet obtained in the second undried-layer forming step S13 for heating and drying, thereby forming a second active material layer 6Z, which will be hereinafter also simply referred to as an active material layer 6Z. After that, the strip-shaped electrode sheet 1Z provided with the active material layers 5Z and 6Z is wound in a roll by use of a wind-up device (not shown).

In this strip-shaped electrode sheet 1Z including the current collecting foil 3 and the active material layers 5Z and 6Z, the central part in the width direction FH forms a strip-shaped active material portion 11Z including the active material layers 5Z and 6Z in the thickness direction GH, and side parts each arranged on one of both sides of the active material portion 11Z in the width direction FH each form a strip-shaped active-material absent portion 12Z having neither the active material portion 5Z nor the active material portion 6Z in the thickness direction GH.

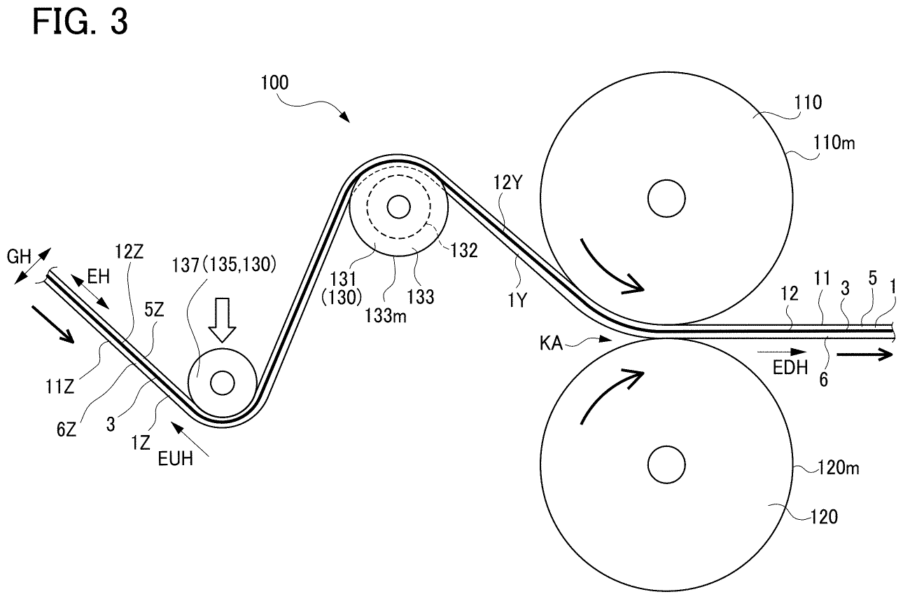

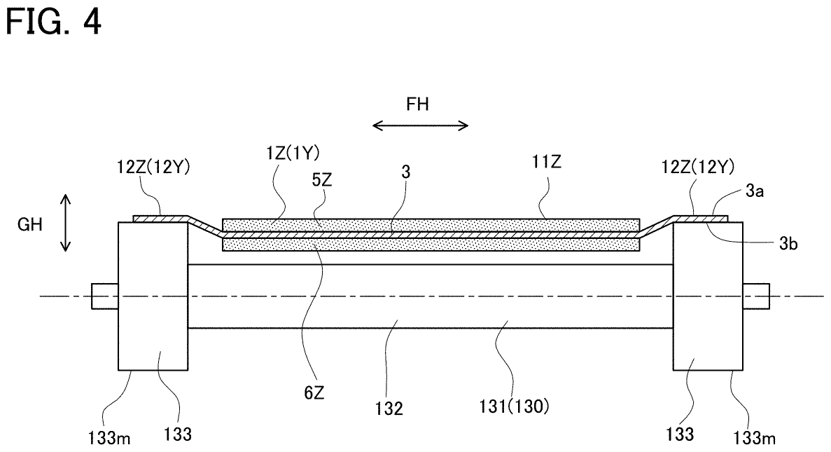

Subsequently, in an active-material-absent-portion stretching step S2 (see FIG. 2), the active-material absent portions 12Z of the strip-shaped electrode sheet 1Z are stretched in the longitudinal direction EH. This active-material-absent-portion stretching step S2 and a pressing step S3 mentioned later are performed continuously by use of a roll press apparatus 100 (see FIGS. 3 and 4).

This roll press apparatus 100 will be described below. The roll press apparatus 100 is provided with a first press roll 110 and a second press roll 120 which are arranged in parallel with each other and spaced with a roll gap KA, and an active-material-absent-portion stretching unit 130 placed on an upstream side EUH (i.e., on a left side in FIG. 3) more than those press rolls 110 and 120. Further, the roll press apparatus 100 also includes a wind-off device (not shown) for winding off the rolled strip-shaped electrode sheet 1Z before roll press and conveying the wound-off the strip-shaped electrode sheet 1Z in the longitudinal direction EH and a wind-up device (not shown) for winding up the compressed strip-shaped electrode sheet 1 after roll press into a roll form.

The first press roll 110 and the second press roll 120 respectively include roll surfaces 110m and 120m, which are made of stainless steel. The first press roll 110 and the second press roll 120 are each connected to corresponding motors (not shown) so that the first press roll 110 is rotatable counterclockwise in FIG. 3 and the second press roll 120 is rotatable clockwise in FIG. 3.

In contrast, the active-material-absent-portion stretching unit 130 is configured to stretch the active-material absent portion 12Z of the strip-shaped electrode sheet 1Z in the longitudinal direction EH. This active-material-absent-portion stretching unit 130 includes a stretching roll 131 and a tension applying part 135 including a tension applying roll 137. The tension applying roll 137 is located on the upstream side EUH (on the left side in FIG. 3) more than and below the stretching roll 131 in FIG. 3.

Specifically, the stretching roll 131 (also see FIG. 4) is a metal roll including a roll central part 132 located in the center in the width direction FH and roll side parts 133 located on both sides of the roll central part 132 in the width direction FH. Each of the roll side parts 133 has a larger diameter than the roll central part 132 and includes a roll surface 133m made of stainless steel. The stretching roll 131 is also a driven roll that rotates as the strip-shaped electrode sheet 1Z is conveyed.

The stretching roll 131 is located under the strip-shaped electrode sheet 1Z being conveyed in FIG. 3 and is configured to come into contact with the strip-shaped electrode sheet 1Z from below with a wrap angle. In the present embodiment, the strip-shaped electrode sheet 1Z wound-off from the wind-off device (not shown) is conveyed in the longitudinal direction EH with the first active material layer 5Z facing up and the second active material layer 6Z facing down in FIGS. 3 and 4. Therefore, the roll central part 132 of the stretching roll 131 faces the second active material layer 6Z of the active material portion 11Z of the strip-shaped electrode sheet 1Z with a gap. In contrast, the roll surfaces 133m of the roll side parts 133 come into pressure contact with corresponding parts of the second main surface 3b of the current collecting foil 3, which form the active-material absent portions 12Z of the strip-shaped electrode sheet 1.

The tension applying part 135 including the tension applying roll 137 having a columnar shape. This tension applying roll 137 is configured to come into contact with the strip-shaped electrode sheet 1Z being conveyed, from above in FIG. 3, to press down the strip-shaped electrode sheet 1Z to apply a tension to the strip-shaped electrode sheet 1Z in the longitudinal direction EH so that this tension is adjustable. Accordingly, the active-material absent portions 12Z of the strip-shaped electrode sheet 1Z contacting with the corresponding roll side parts 133 of the stretching roll 131 are subjected to a tension in the longitudinal direction EH. Depending on the magnitude of this tension, the active-material absent portions 12Z are strained and stretched in the longitudinal direction EH.

In the active-material-absent-portion stretching step S2, the strip-shaped electrode sheet 1Z conveyed from the wind-off device (not shown) in the longitudinal direction EH is pressed down by the tension applying part 135 of the active-material-absent-portion stretching unit 130, so that the tension applied to the strip-shaped electrode sheet 1Z in the longitudinal direction EH is increased. Thus, the active-material absent portions 12Z of the strip-shaped electrode sheet 1Z each contacting with one of the roll side parts 133 of the stretching roll 131 are subjected to a large tension in the longitudinal direction EH. The active-material absent portions 12Z are therefore strained and stretched in the longitudinal direction EH. In the present embodiment, the tension applying part 135 is adjusted, for example, by adjusting the position of the tension applying roll 137 relative to the strip-shaped electrode sheet 1Z, so that a stretch ratio ε1 of the active-material absent portions 12Z in the longitudinal direction EH to be stretched in the active-material-absent-portion stretching step S2 is 0.85% (ε1=0.85%). Herein, the stretched active-material absent portions are also each referred to as an active-material absent portion 12Y, and the strip-shaped electrode sheet including this active-material absent portion 12Y is also referred to as a strip-shaped electrode sheet 1Y.

In the pressing step S3, successively, by use of the aforementioned roll press apparatus 100 (see FIGS. 3 and 4), the strip-shaped electrode sheet 1Y having the stretched active-material absent portions 12Y is roll-pressed while being conveyed in the longitudinal direction EH so that the active material layers 5Z and 6Z are each compressed in the thickness direction GH to form the compressed strip-shaped electrode sheet 1 provided with the compressed active material layers 5 and 6.

In the pressing step S3, specifically, the strip-shaped electrode sheet 1Z conveyed from the active-material-absent-portion stretching unit 130 in the longitudinal direction EH is roll-pressed by the first press roll 110 and the second press roll 120, and the active material layers 5Z and 6Z are compressed, or compressed, in the thickness direction GH, so that the compressed strip-shaped electrode sheet 1 with the compressed active material layers 5 and 6 is continuously produced. This compressed strip-shaped electrode sheet 1 is then wound up in a roll by the wound-up device (not shown).

In the above-described pressing step S3, the active material portion 11Z of the strip-shaped electrode sheet 1Y is stretched in the longitudinal direction EH, whereas the active-material absent portions 12Z having a thin thickness are hardly pressed and thus hardly stretched. In the present embodiment, the line pressure applied by the first press roll 110 and the second press roll 120 is adjusted so that the stretch ratio ε2 of the active material portion 11Z to be stretched in the longitudinal direction EH in the pressing step S3 is 0.86% (ε2=0.86%).

At that time, the active-material absent portions 12Z have been stretched in advance in the longitudinal direction EH in the foregoing active-material-absent-portion stretching step S2. Accordingly, in the compressed strip-shaped electrode sheet 1 after roll press, not only the post-press active material portion 11 has been stretched in the longitudinal direction EH but also the post-press active-material absent portions 12 have been stretched in the longitudinal direction EH. This configuration suppresses the post-press active material portion 11 of the compressed strip-shaped electrode sheet 1 after roll press from slackening, and the tension applied to the compressed strip-shaped electrode sheet 1 toward the downstream side EDH is applied not only to the post-press active-material absent portions 12 but also to the post-press active material portion 11. It is therefore possible to suppress concentration of a large reaction force on a portion of each post-press active-material absent portion 12 located near the boundary between each post-press active-material absent portion 12 and the post-press active material portion 11 and hence prevent oblique wrinkles from occurring in the post-press active-material absent portions 12 concentrically near the boundary.

### Experimental Results

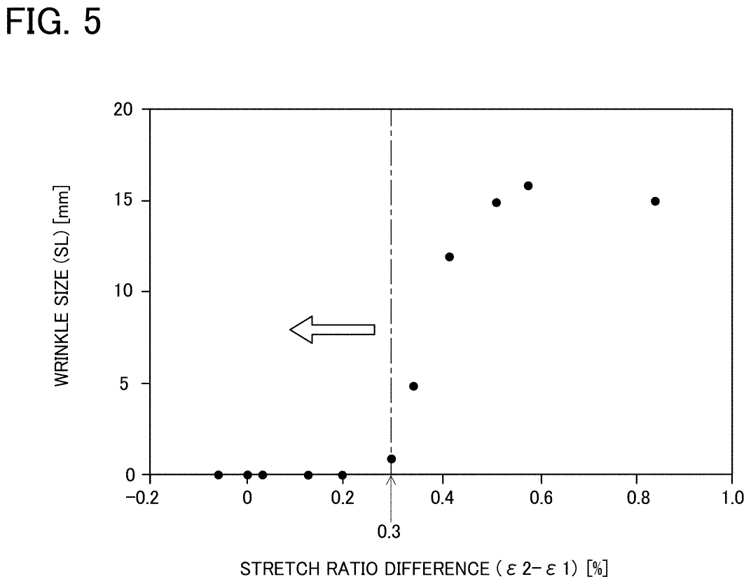

Next, the following description is made on the results of experiments performed to verify a relationship between wrinkles generated in a part of the current collecting foil 3 that constitutes the post-press active-material absent portions 12 and a difference (ε2−ε1) between the stretch ratio ε1 of the active-material absent portion and the stretch ratio ε2 of the active material portion (see Table 1 and FIG. 5).

As shown in Table 1, the compressed strip-shaped electrode sheets 1 in experimental examples 1 to 11 were produced and the size SL of a wrinkle (mm) generated in each current collecting foil 3 that forms each post-press active-material absent portion 12 was investigated. To be specific, the electrode sheet forming step S1, the active-material-absent-portion stretching step S2, and the pressing step S3 were performed in the same manner as in the foregoing embodiment to produce a compressed strip-shaped electrode sheet 1 in each experiment. However, as shown in Table 1, the stretch ratio ε1 (%) for stretching the active-material absent portions 12Z in the longitudinal direction EH in the active-material-absent-portion stretching step S2 and the stretch ratio ε2 (%) for stretching the active material portion 11Z in the longitudinal direction EH in the pressing step S3 were variously set to produce the compressed strip-shaped electrode sheets 1 different between the experimental examples.

As described above, the stretch ratio ε1 is calculated as follows: the marking lines (not shown) are previously drawn at the predetermined interval L1 (L1=1000 mm in each experimental example and the embodiment) in the longitudinal direction EH on the active-material absent portion 12Z of the strip-shaped electrode sheet 1Z before being stretched in the active-material-absent-portion stretching step S2, and then the interval L2 between the marking lines on the active-material absent portion 12Y after the active-material-absent-portion stretching step S2 is measured to obtain the stretch ratio ε1 by an expression: ε1=(L2−L1)/L1×100(%).

Further, the stretch ratio ε2 is calculated as follows: the marking lines (not shown) are previously drawn at the predetermined interval L3 (L3=1000 mm in each experimental example and the embodiment) in the longitudinal direction EH on the active material portion 11Z of the strip-shaped electrode sheet 1Y before being stretched in the pressing step S3, and the interval L4 between the marking lines (not shown) on the post-press active material portion 11 after the pressing step S3 is measured to obtain the stretch ratio ε2 by an expression: ε2=(L4−L3)/L3×100(%).

TABLE 1

| | Stretch ratio (ε1) | Stretch ratio (ε2) | Difference in | |
|---|---|---|---|---|
| | of Active-material | of Active-material | Stretch ratio | |
| Experimental | absent portion | portion | (ε2 − ε1) | Wrinkle Size |
| Example | (%) | (%) | (%) | (SL) (mm) |
| 1 | 0.00 | 0.85 | 0.85 | 15.0 |
| 2 | 0.85 | 0.86 | 0.01 | 0.5 or less |
| 3 | 0.67 | 0.80 | 0.13 | 0.5 or less |
| 4 | 0.89 | 0.84 | −0.05 | 0.5 or less |
| 5 | 0.53 | 0.83 | 0.30 | 1.0 |
| 6 | 0.27 | 0.85 | 0.58 | 15.0 |
| 7 | 0.58 | 0.61 | 0.03 | 0.5 or less |
| 8 | 0.41 | 0.62 | 0.21 | 0.5 or less |
| 9 | 0.27 | 0.62 | 0.35 | 5.0 |
| 10 | 0.19 | 0.61 | 0.42 | 12.0 |
| 11 | 0.10 | 0.62 | 0.52 | 16.0 |

For the compressed strip-shaped electrode sheet 1 produced in each experimental example, the wrinkle size SL (mm) of each wrinkle generated in the current collecting foil 3 that forms the post-press active-material absent portion 12 was measured. This measurement was concretely performed by putting the compressed strip-shaped electrode sheet 1 in each experimental example on an electrostatic adsorption stage and electrostatically adsorbing the sheet 1 thereto, and then measuring wrinkles extending from the inside of the post-press active-material absent portion 12 in the width direction FH, i.e., the boundary between the post-press active-material absent portion 12 and the post-press active material portion 11, toward the outside of the post-press active-material absent portion 12 in the width direction FH. Among the measured lengths of the wrinkles, a longest one is assumed as a wrinkle size SL (mm) in each experimental example. FIG. 5 is a graph showing a relationship between the difference in stretch ratio (ε2−ε1) and the wrinkle size SL (mm) generated in the current collecting foil 3 that forms the post-press active-material absent portion 12.

As is clear from FIG. 5, when the stretch ratio difference (ε2−ε1) is too large, concretely, exceeds 0.3%, a large wrinkle occurs in the post-press active-material absent portion 12. In contrast, when the stretch ratio difference (ε2−ε1) is reduced to fall within a range of ε2−ε1≤0.3(%), little wrinkle occurs in the post-press active-material absent portion 12. This result reveals that it is preferable to adjust the stretch ratio ε1 of the active-material absent portion 12Z in the active-material-absent-portion stretching step S2 and the stretch ratio ε2 of the active material portion 11Z in the pressing step S3 to meet the relation: ε2−ε1≤0.3(%) to produce the compressed strip-shaped electrode sheet 1.

According to the roll press apparatus 100 and the method for producing the compressed strip-shaped electrode sheet 1 using the roll press apparatus 100, as described above, in the active-material-absent-portion stretching step S2 before the pressing step S3, the active-material absent portion 12Z of the strip-shaped electrode sheet 1Z is stretched in the longitudinal direction EH by the active-material-absent-portion stretching unit 130 of the roll press apparatus 100. In the compressed strip-shaped electrode sheet 1 after roll press, therefore, not only the post-press active material portion 11 has been stretched in the longitudinal direction EH by the press rolls 110 and 120, but also the post-press active-material absent portions 12 have also been stretched in the longitudinal direction EH by the active-material-absent-portion stretching unit 130. This configuration suppresses the post-press active material portion 11 of the compressed strip-shaped electrode sheet 1 after roll press from slackening and causes the tension applied on the compressed strip-shaped electrode sheet 1 toward the downstream side EDH to be applied on not only the post-press active-material absent portions 12 but also the post-press active material portion 11. It is thus possible to suppress concentration of a large reaction force on a part of each post-press active-material absent portion 12 located near the boundary between each post-press active-material absent portion 12 and the post-press active material portion 11, and hence prevent the occurrence of oblique wrinkles in each post-press active-material absent portion 12 concentrically near this boundary.

Furthermore, the roll press apparatus 100 is provided with the active-material-absent-portion stretching unit 130 including the stretching roll 131. With this active-material-absent-portion stretching unit 130, the active-material absent portions 12Z of the strip-shaped electrode sheet 1Z are easily stretched in the longitudinal direction EH.

According to the production method of the compressed strip-shaped electrode sheet 1, further, a difference between the stretch ratio ε1 (%) for stretching the active-material absent portion 12Z in the active-material-absent-portion stretching step S2 and the stretch ratio ε2 (%) for stretching the active material portion 11Z in the pressing step S3 is set small, specifically, to meet the following relation: ε2−ε1≤0.3(%). This configuration can effectively suppress the occurrence of wrinkles in the active-material absent portions 12Z (i.e., the post-press active-material absent portions 12).

The present disclosure is described in the foregoing embodiments but not limited to the embodiments. The present disclosure may be embodied in other specific forms without departing from the essential characteristics thereof.

In the aforementioned embodiment, for example, the present disclosure is applied to the compressed strip-shaped electrode sheet 1 which is a positive electrode sheet. As an alternative, the present disclosure may be applied to a compressed strip-shaped electrode sheet 1 which is a negative electrode sheet.

The present embodiment uses the stretching roll 131 of the active-material-absent-portion stretching unit 130 for a rolling work to elongate the active-material absent portions 12Z of the strip-shaped electrode sheet 1Z in the longitudinal direction EH, but it is not limited thereto.

For example, the active-material absent portions 12Z of the strip-shaped electrode sheet 1Z may be roll-pressed by a pair of stepped press rolls configured to come into contact with the active-material absent portions 12Z to elongate the active-material absent portions 12Z in the longitudinal direction EH.

As an alternative, the active-material absent portions 12Z of the strip-shaped electrode sheet 1Z may be heated while being strained in the longitudinal direction EH to elongate the active-material absent portions 12Z in the longitudinal direction EH.

### REFERENCE SIGNS LIST

1 Compacted strip-shaped electrode sheet
1Z Strip-shaped electrode sheet (formed in electrode-sheet forming step)
1Y Strip-shaped electrode sheet (subjected to active-material-absent-portion stretching step)
3 Current collecting foil
5 First compressed active material layer
5Z First active material layer
6 Second compressed active material layer
6Z Second active material layer
11 Post-press active material portion
11Z Active material portion
12 Post-press active-material absent portion
12Z Active-material absent portion
12Y Active-material absent portion (stretched in the active-material-absent-portion stretching step)
100 Roll press apparatus
110 First press roll
120 Second press roll
130 Active-material-absent-portion stretching unit
EH Longitudinal direction
EUH Upstream side
EDH Downstream side
FH Width direction
GH Thickness direction
KA Roll gap
ε1 Stretch ratio (of active-material absent portion in longitudinal direction)
ε2 Stretch ratio (of active material portion in longitudinal direction)
S1 Electrode-sheet forming step
S2 Active-material-absent-portion stretching step
S3 Pressing step

What is claimed is:

1. A roll press apparatus configured to form a compressed strip-shaped electrode sheet from a strip-shaped electrode sheet,
the strip-shaped electrode sheet including a strip-shaped current collecting foil and a strip-shaped active material layer located on the current collecting foil and extended in a longitudinal direction of the current collecting foil to provide:
a strip-shaped active material portion extended in the longitudinal direction and including the active material layer in a thickness direction of the current collecting foil; and
a strip-shaped active-material absent portion extended in the longitudinal direction and arranged adjacent to the active material portion in a width direction of the current collecting foil, wherein the active-material absent portion does not include the active material layer in the thickness direction and has a thinner thickness than the active material portion,
the compressed strip-shaped electrode sheet including a compressed active material layer formed by compression of the active material layer,
wherein the roll press apparatus includes:
a pair of press rolls arranged in parallel with each other with a roll gap, the press rolls being configured to roll-press the strip-shaped electrode sheet being conveyed in the longitudinal direction to compress the active material layer to form the compressed active material layer; and
an active-material-absent-portion stretching unit arranged upstream of the pair of press rolls and configured to stretch the active-material absent portion of the strip-shaped electrode sheet in the longitudinal direction.

2. The roll press apparatus according to claim 1, wherein the active-material-absent-portion stretching unit includes a stretching roll configured to come into pressure contact with the active-material absent portion of the strip-shaped electrode sheet to strain and stretch the active-material absent portion in the longitudinal direction.

3. A method for producing a compressed strip-shaped electrode sheet, the compressed strip-shaped electrode sheet including: a strip-shaped current collecting foil; and a compressed active material layer compressed in a thickness direction of the current collecting foil,
wherein the compressed strip-shaped electrode sheet is formed of a strip-shaped electrode sheet,
the strip-shaped electrode sheet including the current collecting foil and a strip-shaped active material layer located on the current collecting foil and extended in a longitudinal direction of the current collecting foil to provide:
a strip-shaped active material portion extended in the longitudinal direction and including the active material layer in the thickness direction of the current collecting foil; and
a strip-shaped active-material absent portion extended in the longitudinal direction and arranged adjacent to the active material portion in a width direction of the current collecting foil, wherein the active-material absent portion does not include the active material layer in the thickness direction and has a thinner thickness than the active material portion; and
wherein the method includes:
active-material-absent-portion stretching of stretching the active-material absent portion of the strip-shaped electrode sheet in the longitudinal direction of the current collecting foil; and
pressing of roll-pressing the strip-shaped electrode sheet being conveyed after the active-material-absent-portion stretching to compress the active material layer to form the compressed strip-shaped electrode sheet including the compressed active material layer.

4. The method for producing a compressed strip-shaped electrode sheet according to claim 3, wherein a difference between a stretch ratio of the active-material absent portion stretched in the longitudinal direction in the active-material-absent-portion stretching and a stretch ratio of the active material portion stretched in the longitudinal direction in the pressing is 0.3% or less, which is expressed by ε2−ε1≤0.3%, wherein ε1 is the stretch ratio of the active-material absent portion and ε2 is the stretch ratio of the active material portion.
